(19) United States
(12) Patent Application Publication
(10) Pub. No.: US 2017/0034009 A1
(43) Pub. Date: Feb. 2, 2017

(54) INFORMATION PROCESSING METHOD, TRANSMISSION DEVICE, AND STORAGE MEDIUM

(71) Applicant: FUJITSU LIMITED, Kawasaki-shi (JP)

(72) Inventors: JUMPEI HONGO, Kawasaki (JP); Hirotaka Yamada, Kawasaki (JP); KOICHIRO HOJO, Yokohama (JP)

(73) Assignee: FUJITSU LIMITED, Kawasaki-shi (JP)

(21) Appl. No.: 15/205,865

(22) Filed: Jul. 8, 2016

(30) Foreign Application Priority Data
Jul. 30, 2015 (JP) 2015-150325

(51) Int. Cl. H04L 12/24; H04L 12/26

(52) U.S. Cl. CPC H04L 41/142; H04L 43/16; H04L 43/0811; H04L 41/06; H04L 41/22; H04L 43/067

(57) ABSTRACT

An information processing method executed by a transmission device coupled to a plurality of communication paths, the transmission device including an input-side first interface device and a plurality of second interface devices in a subsequent stage of the first interface device, the information processing method includes obtaining, by the first interface device, statistical information on the communication paths at predetermined time intervals; when it is determined that a path in which a cumulative value of the statistical information exceeds a predetermined threshold value or a path in which loss of communication occurs is detected in the communication paths, notifying a relevant interface device of an alert, the relevant interface device being one of the plurality of second interface devices and using the detected path; and changing, by the relevant interface device, a frequency of obtaining the statistical information corresponding to at least the detected path, when the alert is received.

### CROSS-REFERENCE TO RELATED APPLICATION

This application is based upon and claims the benefit of priority of the prior Japanese Patent Application No. 2015-150325 filed on Jul. 30, 2015, the entire contents of which are incorporated herein by reference.

### FIELD

The embodiment discussed herein is related to an information processing method, a transmission device, and a storage medium.

### BACKGROUND

Normally, a network administrator profiles a user traffic and/or an application traffic flowing through a network to obtain detailed information on the traffic on the network. The detailed information includes statistical information. The statistical information indicates a cumulative count number such as the number of packets or the number of octets transmitted/received or discarded in communication, for instance. The statistical information is collected from the interface cards or the like of the transmission devices included in a network. The statistical information is useful when a performance-related problem in communication is diagnosed. The statistical information is periodically obtained and cumulatively stored, and is used as history information to be utilized for a maintenance operation later.

In general, a transmission device manages statistical information for each of communication paths. In order to process statistical information, a dedicated hardware circuit such as a hardware counter including a field programmable gate array (FPGA) is mounted. However, reading statistical information for several thousands of paths from a hardware counter all at once by polling for every second for instance causes the load of a processor to increase, and performance such as redundant switching time may be affected. In order to solve such a problem, in some cases in the related art, the number of paths obtained at a time by polling is limited and the statistical information for all paths is obtained by polling several times.

In a known related art (for instance, Japanese Laid-open Patent Publication No. 2014-67232), an order of priority for re-collecting performance information is determined according to a priority calculated based on at least one parameter related to the performance information, and thus statistical information is collected in consideration of a processing load.

However, with the above-mentioned related art that limits the number of paths obtained at a time by polling, polling has to be conducted several times until the statistical information for all paths is obtained. Therefore, for instance when the number of paths is several thousands, even with the processing of 100 paths by polling for every second for instance, it takes several tens of seconds until the statistical information for all paths is obtained. As a result, a problem arises in that issuing a notification of deterioration of performance or an alert of signal interruption based on a result of collection of the statistical information may be delayed, and thus an occurrence of a network failure may spread to other areas.

With the above-described related art that determines an order of priority and re-collects performance information, it is possible to determine and collect performance information with a higher priority. Here, in a transmission device, a dedicated hardware of each interface card independently collects statistical information. For instance when an alert of deterioration of communication performance occurs in an interface card during the collection, the related art allows the priority of collection of statistical information from the card to be increased. However, for instance, as in a situation of the Ingress side and the Egress side, in another interface card connected to an interface card in which an alert occurs, the priority of collection of statistical information is not changed yet and thus issuing of an alert may be delayed.

Alternatively, for instance when an alert of signal interruption occurs in an interface card, the related art allows collection of statistical information from the card to be stopped. However, in another interface card connected to the interface card in which an alert occurs as described above, collection of unnecessary statistical information may be continued. For this reason, in the transmission device, it is desirable to control the priority of collection of statistical information in subsequent stage units by constructing a mechanism that notifies the subsequent stage units of detection of an alert of deterioration of performance or signal interruption in an input unit.

### SUMMARY

According to an aspect of the invention, an information processing method executed by a transmission device coupled to a plurality of communication paths, the transmission device including an input-side first interface device and a plurality of second interface devices in a subsequent stage of the first interface device, the information processing method includes obtaining, by the first interface device, statistical information on the plurality of communication paths at predetermined time intervals; when it is determined that a path in which a cumulative value of the statistical information exceeds a predetermined threshold value or a path in which loss of communication occurs is detected in the plurality of communication paths, notifying a relevant interface device of an alert, the relevant interface device being one of the plurality of second interface devices and using the detected path; and changing, by the relevant interface device, a frequency of obtaining the statistical information corresponding to at least the detected path, when the alert is received from the first interface device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example configuration of a network to which this embodiment is applied;

FIG. 2 is an explanatory diagram of an example hardware configuration of L2 switch and a communication path;

FIG. 3 is a configuration diagram for illustrating the basic operation of this embodiment;

FIG. 4 illustrates an example configuration of a statistical information processor;

FIG. 5 illustrates examples of collection items of statistical information from each interface card on the Ingress side and the Egress side;

FIG. 6 is an explanatory diagram of a polling operation with the number of FPs limited;

FIG. 7 is an explanatory diagram (part 1) for a problem in statistical information collection;

FIG. 8 is an explanatory diagram (part 2) for a problem in statistical information collection;

FIG. 9 is a diagram illustrating an example hardware configuration of an embodiment of a transmission device;

FIG. 10 is a diagram illustrating an example frame format;

FIG. 11 is a diagram illustrating a detailed example configuration of the statistical information processor;

FIGS. 12A and 12B are each an explanatory diagram of processing of registration to a Path table;

FIG. 13 is an explanatory diagram (part 1) of an operation of controlling the frequency of collection of statistical information;

FIG. 14 is an explanatory diagram (part 2) of the operation of controlling the frequency of collection of statistical information; and

FIG. 15 is a flow chart illustrating an example of statistical information collection control processing performed by an entire controller.

### DESCRIPTION OF EMBODIMENT

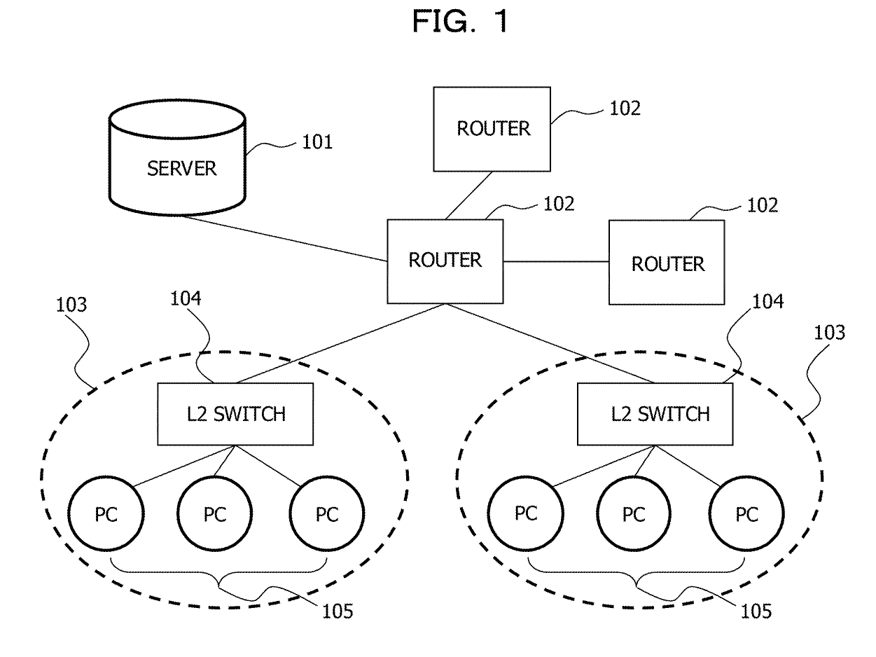

Hereinafter, an embodiment of the disclosure will be described with reference to the drawings. This embodiment is directed to statistical information collected by various transmission devices from L0 (layer 0) to L4 (layer 4). FIG. 1 illustrates an example configuration of a network to which the embodiment is applied. The example configuration has a configuration in which personal computers (PCs) 105 are organized by L2 (layer 2) switch 104 in each of in-house local area networks (LAN) 103. Each in-house LAN 103 is connected via routers 102 to computers in a server 101 on an external Internet, for instance. Here, an embodiment of a transmission device to which the disclosure is applied is, for instance, L2 switch 104 of FIG. 1. Not only L2 switch but also a switch in another layer may be an embodiment.

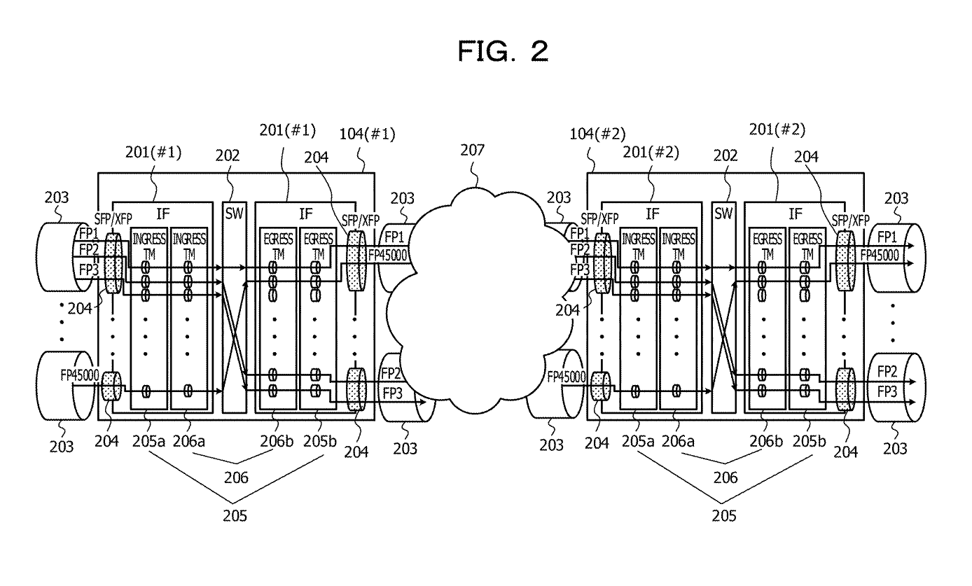

FIG. 2 is an explanatory diagram of an example hardware configuration of L2 switch 104 of FIG. 1 and a communication path. Two L2 switches 104 with #1 and #2 perform communication via a network 207 such as a local area network. For each of communication paths, packet (frame) data is transmitted therethrough.

Each of the L2 switches 104 with #1 and #2 includes, for instance, a plurality of (#1 and #2 in the example of FIG. 2) interface cards (“IF” in FIG. 2) 201, at which transmission lines 203 formed of an optical fiber terminate, and a switch card 202.

Each of the transmission lines 203 is connected via a SFP/XFP transceiver 204 to a port which is a physical terminal end of a corresponding one of the interface cards 201. The transmission line 203 formed of an optical fiber terminates at the SFP/XFP transceiver 204. The SFP/XFP transceiver 204 is an optical transceiver module in accordance with SFP or XFP standard. The SFP/XFP transceiver 204 performs mutual conversion between an optical communication signal inputted/outputted to the transmission line 203, and an electrical transmission signal inputted/outputted to a port in the interface card 201. SFP stands for Small Form factor Pluggable standard. XFP stands for 10(X) Gigabit small Form factor Pluggable standard.

The interface card 201 includes a network processor unit (NPU) 205 and a traffic management integrated circuit (TM) 206. The NPU 205 functionally includes an input-side (Ingress side) NPU 205a and an output-side (Egress side) NPU 205b. The TM 206 also functionally includes the Ingress side TM 206a and the Egress side TM 206b. In order to clarify the flow of the communication path, the functions of the units on the Ingress side and the Egress side are separately illustrated in FIG. 2. Practically, however, both functions are combined together to achieve the NPU 205 or the TM 206.

First, the operation of the interface card 201 on the Ingress side will be described. The Ingress side NPU 205a checks the label value of a receive packet received from the transmission line 203 on the Ingress side via the SFP/XFP transceiver 204 and the port. The Ingress side NPU 205a then adds an in-device header, which includes information corresponding to the label value, to the receive packet. Subsequently, the Ingress side NPU 205a transfers the receive packet with the in-device header to the Ingress side TM 206a.

The Ingress side TM 206a transfers the receive packet to the switch card 202 while performing traffic policing for limiting the output rate by discarding excess traffic which has reached a maximum rate set for the packet.

The switch card 202 transfers the packet to the interface card 201 on the Egress side according to the information in the in-device header of the packet inputted from the Ingress side TM 206a in the interface card 201 on the Ingress side.

Next, the operation of the interface card 201 on the Egress side will be described. The Egress side TM 206b transfers a transmission packet from the switch card 202 to the Egress side NPU 205b while performing traffic shaping in which an excess packet is placed in a queue for the transmission packet and is transmitted at regular time intervals. Consequently, the output rate of the transmission packet is smoothed.

The Egress side NPU 205b removes the in-device header added to the transmission packet which is received from the Egress side TM 206b. The Egress side NPU 205b then changes the label value in the transmission packet to an output label value according to the information in the in-device header.

Consequently, the transmission packet outputted from the Egress side NPU 205b is sent to the transmission line 203 on the Egress side via the port and the SFP/XFP transceiver 204.

Normally, a plurality of L2 switches 104 may be mounted in a housing called shelf. For this reason, each L2 switch 104 is identified by a shelf number that indicates the shelf in which the L2 switch 104 installed. For instance, in FIG. 2, L2 switch 104 (#1) has shelf number #1. L2 switch 104 (#2) has shelf number #2.

Here, for instance, the communication path of a packet associated with a communication in L2 switch 104 (#1) with shelf number #1 is as follows. A packet is inputted from a transmission line 203 on the Ingress side to a port with port number #1, for instance, of the interface card 201 (#1) on the Ingress side inserted in the slot with slot number #1 in the L2 switch 104 (#1), for instance. The Ingress side NPU 205a and the Ingress side TM 206a in the interface card 201 (#1) in the slot with slot number #1 on the Ingress side perform transmission processing of the packet as described above, and outputs the packet to the switch card 202. The switch card 202, after switching the packet as described above, inputs the packet to the interface card 201 (#2) on the Egress side, mounted in the slot with slot number #2 in the L2 switch 104 (#1), for instance. The Egress side NPU 205b and the Egress side TM 206b in the interface card 201 (#2) on the Ingress side in the slot with slot number #2 perform transmission processing of the packet as described above. The packet is outputted to the transmission line 203 on the Egress side from the port with port number #1 of the interface card 201 (#2) on the Egress side of the slot with slot number #2, for instance.

In the example described above, a packet associated with a communication is inputted to the port with port number #1 of the interface card 201 (#1) on the Ingress side in the slot with slot number #1 of the L2 switch 104 (#1) with shelf number #1. The packet is then outputted from the port with port number #1 of the interface card 201 (#2) on the Egress side in the slot with slot number #2 of the L2 switch 104 (#1) with shelf number #1.

Thus, a communication path of a packet associated with a communication is identifiable by a pair of information in combination of a shelf number, a slot number and a port number on the Ingress side, and information in combination of a shelf number, a slot number and a port number on the Egress side. However, communication paths having different destinations may be present on a single port. Thus, the input flow point (hereinafter referred to as an “input FP”) is defined as the information that includes a shelf number, a slot number, a port number on the Ingress side, and further includes a serial number of a communication path on the port number. Similarly, the output flow point (hereinafter referred to as an “output FP”) is defined as the information that includes a shelf number, a slot number, a port number on the Egress side, and further includes a serial number of a communication path on the port number. Specifically, each of the input FP and output FP is expressed in the data format “shelf number-slot number-port number-serial number” with adjacent numbers connected with a hyphen. In this manner, a communication path of a packet associated with a communication is identifiable by a combination of an input FP and an output FP. An input flow point (input FP) and an output flow point (output FP) are collectively referred to as a flow point (FP).

In the example described above, a communication path on the L2 switch 104 (#1) of a packet associated with a communication is identified by the combination of the input FP “1-1-1-1” and the output FP “1-1-1-1”.

A packet outputted from the L2 switch 104 (#1) to the transmission line 203 on the Egress side arrives at the L2 switch 104 (#2) via the network 207. The transmission processing in the L2 switch 104 (#2) is also the same as the transmission processing in the L2 switch 104 (#1). Therefore, a communication path of the packet associated with the communication and transmitted from the L2 switch 104 (#1) is identified by a combination of an input FP and an output FP associated with the L2 switch 104 (#2).

A single L2 switch 104 may recognize each of 4500 communication paths as a combination of an input FP and an output FP.

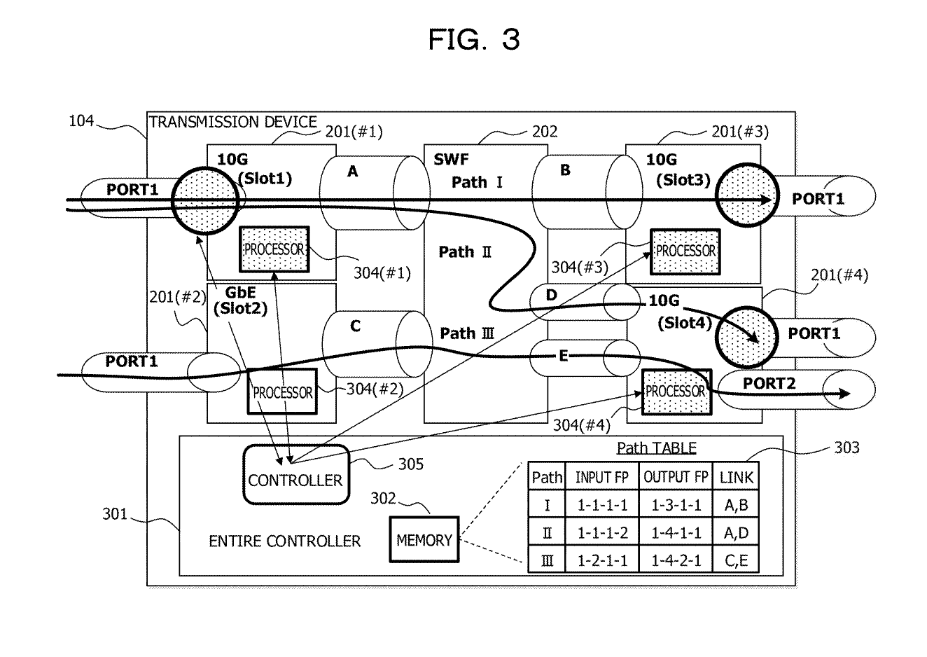

FIG. 3 is a configuration diagram for illustrating the basic operation of the present embodiment. The transmission device 104, the interface cards 201 with #1 to #4, and the switch card (SW) 202 in FIG. 3 are the same as those of the L2 switch 104 in FIG. 1 or FIG. 2. For instance, the interface cards 201 with #1, #3, #4 each terminate a transmission line with 10 Gigabits/sec (denoted by “10G” in FIG. 3). The interface card 201 with #2 terminates a transmission line with 1 Gigabit/sec (denoted by “GbE” in FIG. 3).

In FIG. 3, each interface card 201 in the transmission device 104 manages statistical information for each FP (input FP or output FP) that identifies a communication path. Thus, the interface cards 201 with #1 to #4 include respective statistical information processors 304 (abbreviated as “processors” in FIG. 3) with #1 to #4 for processing statistical information. Each of the statistical information processors 304 collects and accumulates statistical information such as the number/size of packets, the number of discarded packets for each FP. When a cumulative value exceeds a predetermined threshold value, the statistical information processor 304 outputs an alert to the entire controller 301, the alert indicating that the performance of communication processing has reduced. The alert is called a threshold crossing alert (TCA). The statistical information processor 304 is mounted in the NPU 205 (Ingress side NPU 205a or Egress side NPU 205b) of FIG. 2.

The ports (such as PORT1, PORT2) of each interface card 201 detects signal interruption such as LOS (which is not particularly illustrated), and outputs an alert of signal interruption such as LOS alert to the entire controller 301

The entire controller 301 is a processor unit that performs control of each communication path in the transmission device 104. The entire controller 301 includes Path table 303 for controlling the communication paths in an internal memory 302. Hereinafter, each communication path is referred to as a Path. The Path table 303 stores path name or path number such as I, II, III in “Path” item of each entry (row). The Path table 303 stores an input FP and an output FP in the above-described “shelf number-slot number-port number-serial number” format for each of “input FP” item and “output FP” item. In the following description, numbers such as 1st number, 2nd number, 3rd number, 4th number are denoted by #1, #2, #3, #4, respectively.

In FIG. 3, Slot1, Slot2, Slot3, and Slot4 indicate the slots with slot number #1, #2, #3, and #4 in which the interface cards 201 with #1, #2, #3, and #4 are respectively mounted. PORT1 and PORT2 indicate the port with port number #1 and the port with port number #2, respectively in each interface card 201. Let the shelf number of the transmission device 104 be #1.

Now, it is assumed that “Path I” is defined in FIG. 3 from PORT1 of the interface card 201 (#1) of Slot1 to PORT1 of the interface card 201 (#3) of Slot3 via the switch card 202. In this case, value “I” is set as “Path” item for the entry of the 1st row of the Path table 303. On the input side (Ingress side) of Path I, the shelf number is #1, the slot number is #1, and the port number is #1. The serial number of path I at PORT1 of Slot1 is 1. Therefore, the value “1-1-1-1” is stored in “input FP” item for the entry of the 1st row. In addition, on the output side (Egress side) of path I, the shelf number is #1, the slot number is #3, and the port number is #1. The serial number of path I at PORT1 of Slot3 is 1. Therefore, the value “1-3-1-1” is stored in “output FP” item for the entry of the 1st row.

Similarly, it is assumed that “Path II” is defined in FIG. 3 from PORT1 of the interface card 201 (#1) of Slot1 to PORT1 of the interface card 201 (#3) of Slot4 via the switch card 202. In this case, value “II” is set as “Path” item for the entry of the 2nd row of the Path table 303. On the input side of Path II, the shelf number is #1, the slot number is #1, and the port number is #1. The serial number of path II at PORT1 of Slot1 is 2. Therefore, the value “1-1-1-2” is stored in “input FP” item for the entry of the 2nd row. In addition, on the output side of Path II, the shelf number is #1, the slot number is #4, and the port number is #1. The serial number of path II at PORT1 of Slot4 is 1. Therefore, the value “1-4-1-1” is stored in “output FP” item for the entry of the 2nd row.

Similarly, it is assumed that “Path III” is defined in FIG. 3 from PORT1 of the interface card 201 (#1) of Slot2 to PORT2 of the interface card 201 (#3) of Slot4 via the switch card 202. In this case, value “III” is set as “Path” item for the entry of the 3rd row of the Path table 303. On the input side of Path III, the shelf number is #1, the slot number is #2, and the port number is #1. The serial number of path III at PORT1 of Slot2 is 1. Therefore, the value “1-2-1-1” is stored in “input FP” item for the entry of the 3rd row. In addition, on the input side of Path III, the shelf number is #1, the slot number is #4, and the port number is #2. The serial number of path III at PORT2 of Slot4 is 1. Therefore, the value “1-4-2-1” is stored in “output FP” item for the entry of the 3rd row.

In addition to the above-described “Path” item, “input FP” item, and “output FP” item, each entry is provided with “link” item, in which information on a link (physical line) used by a path corresponding to the entry is stored. In the example of FIG. 3, for the entry of “Path I” in FIG. 3, information on link A and link B used by Path I is stored in the “link” item. Similarly, for the entry of “Path II” in FIG. 3, information on link A and link D used by Path II is stored in the “link” item. In addition, for the entry of “Path III” in FIG. 3, information on link C and link E used by Path III is stored in the “link” item.

Next, the entire controller 301 includes a controller 305 as described below. When detection information on deterioration of communication performance or alert of signal interruption based on statistical information is sent from one of the input-side interface cards (units) 201, the controller 305 notifies the IF units 201 in the subsequent stage of the input-side IF unit 201, of the detection information. The statistical information processor 304 in each of the IF units 201 that have received the detection information changes the priority (for instance, the frequency) of collection of statistical information. For instance, when deterioration of the performance of an input-side IF unit is detected, the frequency of collection of statistical information in each IF unit in the subsequent stage is increased. When signal interruption in an input-side IF unit is detected, collection of statistical information in each IF unit in the subsequent stage is stopped.

Specifically, when the controller 305 is notified of the above-mentioned TCA indicating deterioration of the performance of communication of an FP (path) or the above-mentioned alert of signal interruption such as LOS alert at one of ports in one of the interface cards 201 with #1 to #4, the controller 305 performs the following operation. The controller 305 refers to the Path table 303, thereby transmitting a notification to each interface card (unit) 201 in the subsequent stage that handles a path using a link in association with the notification (detection). More specifically, the controller 305 further extracts a path that uses a link corresponding to the interface card 201 which is used by the FP in association with the notification of the alert and which has outputted the alert. The controller 305 then transmits the notification to the statistical information processor 304 in the interface card 201 that handles the extracted path

For instance, the statistical information processor 304 of the interface card 201 (#1) of Slot1 outputs TCA upon detecting that for the input FP “1-1-1-1”, a threshold value for statistical information is exceeded. The controller 305 refers to the entry of Path I, to which the input FP is set, in the Path table 303, thereby extracting link A corresponding to the interface card 201 (#1) of Slot1, which is used by the input FP and which has outputted the alert. The controller 305 further extracts Path II used by the link A, in the Path table 303. The controller 305 then transmits a notification of priority collection of statistical information for the FP corresponding to the extracted Path II to the statistical information processor 304 in each interface card 201 in the subsequent stage of the input-side interface card 201 (#1) of Slot1 used by the extracted Path II. More specifically, the controller 305 refers to the input FP and the output FP set for the entry of Path II in the Path table 303. Consequently, based on the output FP “1-4-1-1”, the controller 305 transmits a notification of priority collection for FP1 to the statistical information processor 304 of the interface card 201 (#4) of Slot4 in the subsequent stage of the interface card 201 (#1) of Slot1.

The statistical information processor 304 of the interface card 201 (#4) of Slot4, which has received the notification of priority collection, increases the frequency of collection of statistical information for the FP designated by the notification of priority collection. For instance, the statistical information processor 304 changes a schedule of collection so that the statistical information for the FP designated by the notification of priority collection is collected for every polling cycle.

For instance, it is assumed that PORT1 of the interface card 201 (#1) of Slot1 outputs an alert of signal interruption. The controller 305 refers to each entry of Path I and Path II, to which the PORT1 of Slot1 is set, in the Path table 303, thereby extracting link A corresponding to the interface card 201 (#1) of Slot1. The controller 305 further extracts Path I and Path II which use the link A, in the Path table 303. The controller 305 then transmits a notification of stop collection of statistical information for the FP corresponding to the extracted Path I and Path II to the statistical information processor 304 in each interface card 201 in the subsequent stage, used by the extracted Path I and Path II. Specifically, the controller 305 refers to the input FP and the output FP set for the entry of Path I in the Path table 303. Consequently, based on the input FP “1-1-1-1”, the controller 305 transmits a notification of stop collection for FP1 to the statistical information processor 304 of the interface card 201 (#1) of Slot1. Based on the output FP “1-3-1-1”, the controller 305 transmits a notification of stop collection for FP1 to the statistical information processor 304 in the interface card 201 (#3) of Slot3. In addition, the controller 305 refers to the input FP and the output FP set for the entry of Path II in the Path table 303. Consequently, based on the output FP “1-4-1-1”, the controller 305 transmits a notification of stop collection for FP1 to the statistical information processor 304 in the interface card 201 (#4) of Slot4 in the subsequent stage of the interface card 201 (#1) of Slot1.

The statistical information processor 304 which has received the notification of priority collection stops collection of statistical information for the FP designated by the notification of priority collection.

In the manner as described above, the present embodiment allows users to be notified of TCA quickly. When an alert due to signal interruption such as a LOS alert is issued, it is possible to notify an interface card 201 that collection of statistical information is unnecessary, so that the notified interface card 201 does not collect statistical information for a relevant FP.

Thus, according to the present embodiment, each unit in the subsequent stage may be notified of information on deterioration of performance or signal interruption in the input-side units without delay, and in the unit in the subsequent stage, the priority (frequency) of collection of statistical information may be changed so that notification of TCA may be made appropriately.

The present embodiment uses L2 (Ethernet) as an example. However, in the case of statistical information of L1 (SONET or SDH), an error count increases due to signal interruption such as LOS, and thus it is desirable that a notification of priority collection be transmitted to increase the priority of collection. In the case of L3 (IP), L4 (TCP/UDP), similar behavior to that of the case of L2 is observed, and in the case of LO, rate of notification of TCA is once increased immediately after detection of LOS. However, statistical information is not changed subsequently, and thus it is sufficient that collection of statistical information be stopped by transmitting a notification of stop collection.

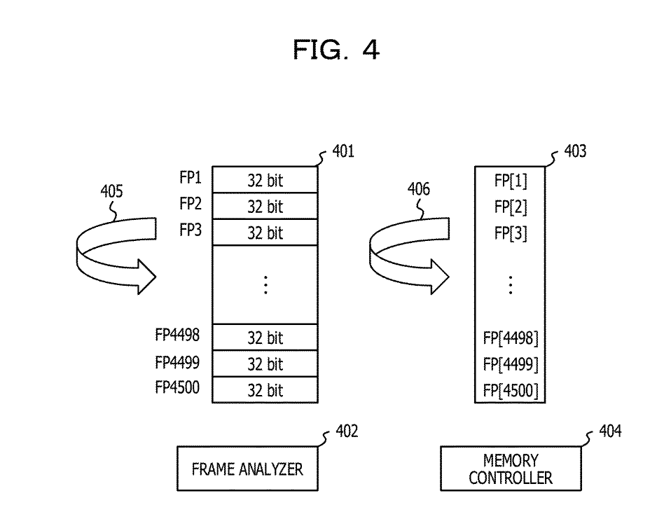

FIG. 4 illustrates a configuration example of the statistical information processors 304 of FIG. 3. The statistical information processors 304 each include, for instance, a hardware counter 401 formed of an FPGA, and a frame analyzer 402. The hardware counter 401 increments a count value of 32-bit statistical information for each of flow points FP1 to FP4500 with #1 to #4500, for instance. The frame analyzer 402 identifies a path (communication path) by analyzing the header of a packet which flows through the transmission path in the interface card 201. The frame analyzer 402 increments the count value, in the hardware counter 401, corresponding to the FP of the path (the operation indicated by an arrow 405 of FIG. 4).

Each of the statistical information processors 304 includes a statistical information memory 403 which is a random access memory (RAM), and a memory controller 404 which is a central processing unit (CPU). The memory controller 404 reads the count value, counted by the hardware counter 401, of statistical information for each FP by cyclic polling. The memory controller 404 then accumulates (the operation indicated by an arrow 406 of FIG. 4) the count value of statistical information for each read FP in FP [1] to FP [4500], each of which is a cumulative value for an FP in the statistical information memory 403. The hardware counter 401 is a Read Clear register. Reading by the memory controller 404 provides the timing for the count value to be cleared to zero. When a cumulative value exceeds a predetermined threshold value, the memory controller 404 notifies the entire controller 301 in FIG. 3 of TCA which indicates that the performance of communication processing has been reduced.

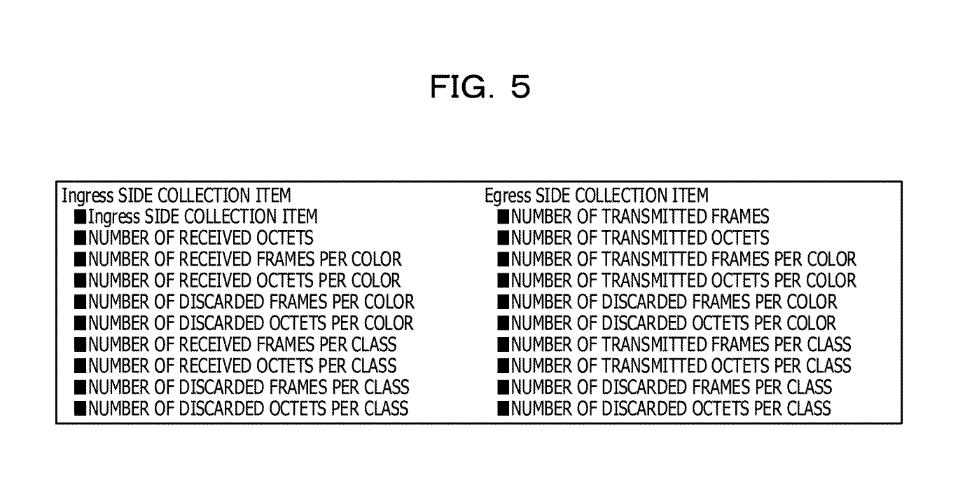

FIG. 5 illustrates examples of collection items of statistical information from each interface card 201 on the Ingress side and the Egress side. The statistical information on the Ingress side includes, for instance, the number of received frames which is the total number of received packets, and the number of received octets which is the total number of octets of received packets. The statistical information on the Ingress side includes the number of received frames, the number of received octets, the number of discarded frames, and the number of discarded octets per color (the latter two are respectively the total number of discarded received packets and the total number of discarded octets) where the paths are divided into Green, Yellow, Red. In addition, the statistical information on the Ingress side includes the number of received frames, the number of received octets, the number of discarded frames, and the number of discarded octets per Class where the paths are divided into some classes.

On the other hand, the statistical information on the Egress side includes, for instance, the number of received frames which is the total number of received packets, and the number of received octets which is the total number of octets of received packets. The statistical information on the Egress side includes the number of transmitted frames, the number of transmitted octets, and the number of discarded frames, the number of discarded octets which are the total number of discarded transmitted packets, the total number of discarded octets, respectively per color mentioned above. In addition, the statistical information on the Egress side includes the number of transmitted frames, the number of transmitted octets, the number of discarded frames, and the number of discarded octets per Class mentioned above.

In FIG. 4, when the CPU 404 performs a read operation indicated by the arrow 406, it is ideal to read the statistical information on all FPs from the hardware counter 401 by polling once every one second, for instance. However, when the amount of statistical information to be collected increases as the number of FPs to be processed by the transmission device 104 (L2 switch) increases, the load of the CPU 404 in the interface card 201 increases, which causes a problem in that the performance in the time of redundant switching (switching between paths) may be affected.

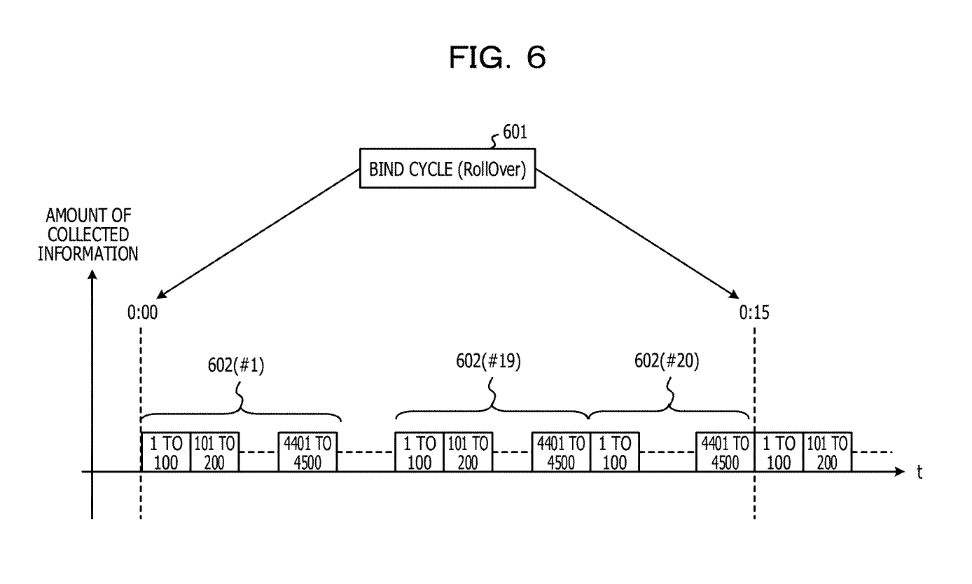

In order to solve this problem, a method is adopted in which statistical information is obtained by polling with a limited number of FPs obtained at a time. FIG. 6 is an explanatory diagram of a polling operation with a limited number of FPs. In FIG. 6, the statistical information obtained at a time by the CPU 404 using polling from the hardware counter 401 is limited to 100 (FP). Increase in the load of the CPU 404 may be reduced by thus limited number of FPs.

In general, the CPU 404 records a history of cumulative values of statistical information on the RAM 403 in a cycle (for instance, 15 minute cycle in FIG. 6) called a bind cycle (Roll Over) indicated by 601 of FIG. 6.

For instance, when polling is performed every one second, the number of FPs per polling is 100. Therefore, for instance, it takes 4500÷100=45 seconds until all polling for 4500 FPs is completed. Also, statistical information is accumulated 15 minutes×60 seconds÷45 seconds=20 times (601(#1) to 601(#20) of FIG. 6) per bind cycle mentioned above.

In this case, however, the interval of collection of statistical information of each FP is 45 seconds as described above. Therefore, when the cumulative value of statistical information for an FP exceeds a threshold value, TCA sent from the CPU 404 in the interface card 201 to the entire controller 301 (FIG. 3) is also delayed by a maximum of 45 seconds.

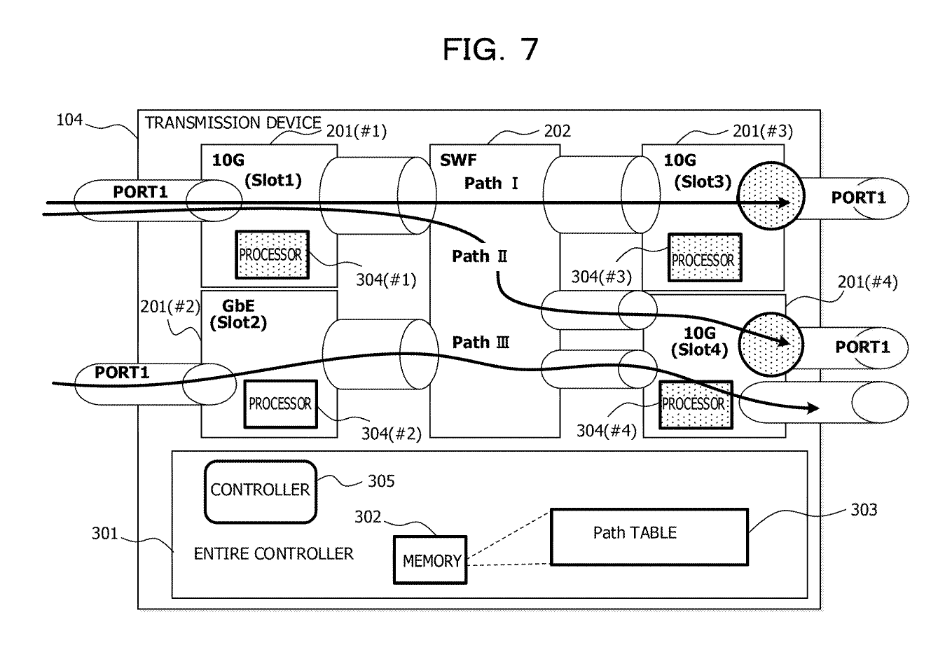

In normal statistical information collection, respective statistical information processors 304 of the interface cards 201 (FIG. 3) independently collect statistical information. Here, for instance, as illustrated in FIG. 7 (the same configuration as in FIG. 3), a case is discussed in which TCA occurs for an FP in the statistical information processor 304 in the interface card 201 (#1) of Slot1. In this case, it is expected that the TCA for the FP also occurs in the respective statistical information processors 304 of the interface cards 201 (#3, #4) of Slot3 or Slot4 which are connected via a link to the interface card 201 (#1) of Slot1. Here, a case is discussed in which the above-described mechanism is not provided that increases the frequency of collection of statistical information by the controller 305. In this case, as illustrated in FIG. 7, even when the cumulative value of statistical information for the FP actually exceeds a threshold value in the respective statistical information processors 304 of the interface cards 201 (#3, #4) of Slot3 or Slot4, delay of a maximum of 45 seconds occurs because of the reason described above.

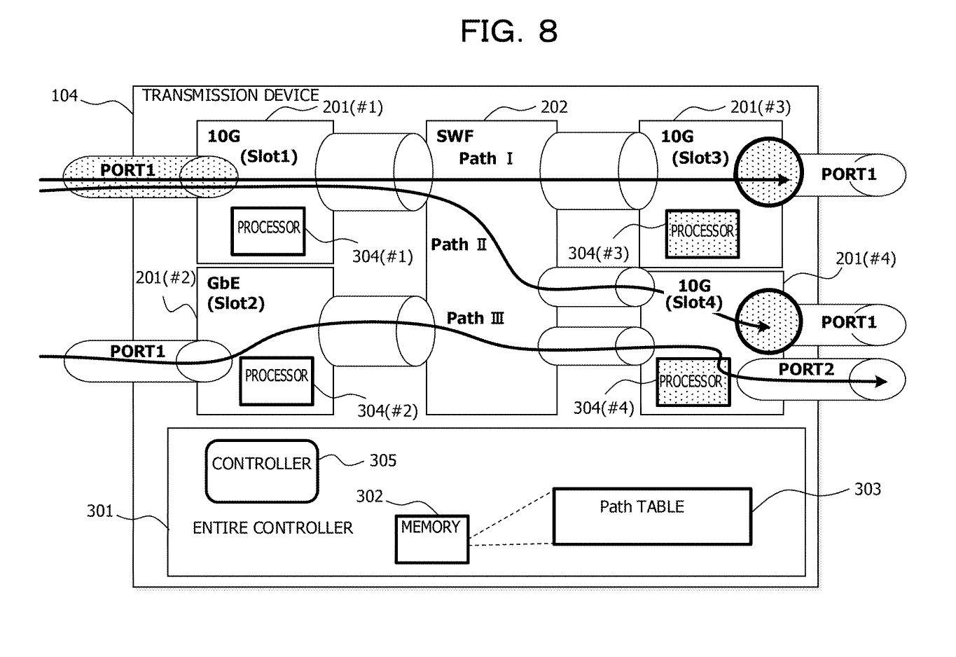

In contrast to the case of TCA described above, for instance, as illustrated in FIG. 8, a case may arise where an alert of signal interruption such as a LOS alert occurs at PORT1 of the interface card 201 (#1) of Slot1. In this case, for each FP that uses the PORT1, it is desirable that the respective statistical information processors 304 of the interface cards 201 (#3, #4) of Slot3 or Slot4 connected via a link to the interface card 201 (#1) of Slot1 stop collection processing of statistical information on the FP in order to reduce CPU load. Also in this case, when the mechanism is not provided that increases the frequency of collection of statistical information by the controller 305, the respective statistical information processors 304 of the interface cards 201 (#3, #4) of Slot3 or Slot4 continue collection processing of needless statistical information.

When the mechanism is not provided that increases the frequency of collection of statistical information by the controller 305 in collection processing of statistical information like this, notification of TCA may be delayed because the statistical information of all Paths are not readable by polling at one time.

At each interface card 201, statistical information is independently collected. For this reason, if the controller 305 is not provided, even when communication performance deteriorates for an FP in an interface card 201, the manner of collection of statistical information is not changed in another interface card 201 which process the FP, and thus notification of TCA may be delayed.

Furthermore, a problem arises in that even when an alert due to signal interruption occurs at a port of an interface card 201, another interface card 201, which process the FP using the port, continues to collect unnecessary statistical information if the controller 305 is not provided.

In order to solve the above-mentioned problem, the above-described controller 305 of FIG. 3 provides a mechanism that allows the input-side interface cards 201 to notify each interface card 201 in the subsequent stage of information on deterioration of performance and an alert of signal interruption or the like. Here, in collection of statistical information for each FP in the statistical information processor 304 in each interface card 201 of FIG. 3, a priority is assigned to the FP. A configuration is adopted in which statistical information having a higher priority is collected for every cycle (every one second) to quickly increase the rate of notification of TCA and unnecessary statistical information is not collected so that load of the CPU 404 (FIG. 3) is reduced.

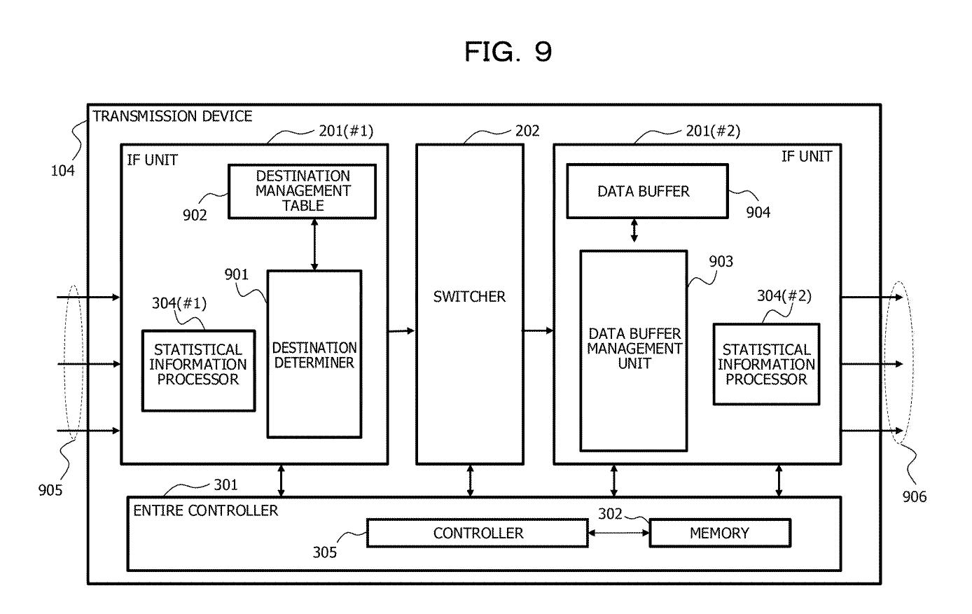

FIG. 9 is a diagram illustrating an example hardware configuration of an embodiment of the transmission device 104 of FIG. 3. Each component labeled with the same reference number as in FIG. 3 has the same function as in FIG. 3.

In the present embodiment, a packet inputted from Ingress-side transmission path 905 is transmitted in the following manner: the Ingress-side IF (interface) unit 201 (#1)→the switcher 202→the Egress-side IF unit 201 (#2)→the Egress-side transmission path 906. FIG. 9 illustrates the processing blocks in the Ingress-side IF unit 201 (#1) (same as 201(#1) of Slot1 of FIG. 3), and the Egress-side IF unit 201 (#2) (same as 201(#3) of Slot3 of FIG. 3). The Ingress-side IF unit 201 (#1) includes a statistical information processor 304 (#1), a destination determiner 901, and a destination management table 902.

The statistical information processor 304 (#1) is the same as the statistical information processor 304 (#2) of FIG. 3.

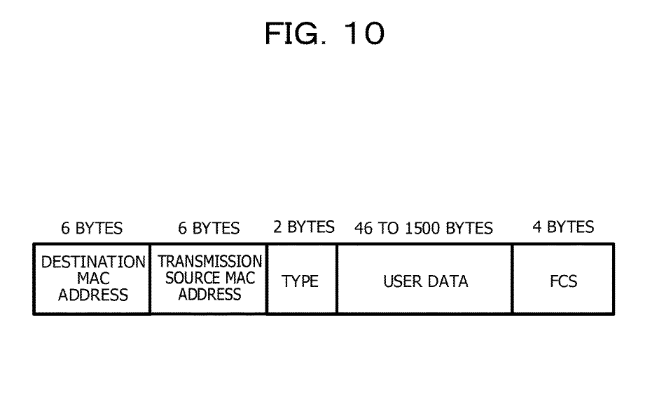

Next, the destination determiner 901 determines a destination of received data based on identification information (such as destination information and service type information) added to the received data, and the content of the destination management table 902. The received data is defined in the frame format illustrated in FIG. 10, for instance. The received data includes the fields of destination media access control (MAC) address, transmission source MAC address, type, User Data, and frame check sequence (FCS). When a virtual local area network (VLAN) is used, a 4-byte frame called a VLAN tag is added to a MAC frame. The destination management table 902 is a table that manages the destination address, the transmission source address, the VLAN ID, and others.

The switcher 202 then switches between output destinations of the received data based on a result of the destination determination by the destination determiner 901. For instance, the switcher 202 generates a transmission data by adding destination information based on the received data, and outputs the transmission data to the Egress-side IF unit 201 (#2).

The Egress-side IF unit 201 (#2) includes a data buffer management unit 903, a data buffer 904, and a statistical information processor 304 (#2).

The data buffer 904 temporarily holds a transmission data according to the timing of transmission of the transmission data inputted from the switcher 202. The data buffer management unit 903 stores a transmission data from the switcher 202 in the data buffer 904, and reads the transmission data stored in the data buffer 904 at a predetermined timing. The Egress-side IF unit 201 (#2) sends the transmission data read from the data buffer 904 to the Egress-side transmission path 906 as an output destination according to the destination information added to the transmission data.

A statistical information processor 304 (#2) of FIG. 9 is the same as the statistical information processor 304 (#3) of FIG. 3.

An entire controller 301, a controller 305, and a memory 302 of FIG. 9 are the same as the entire controller 301, the controller 305, and the memory 302 of FIG. 3, respectively.

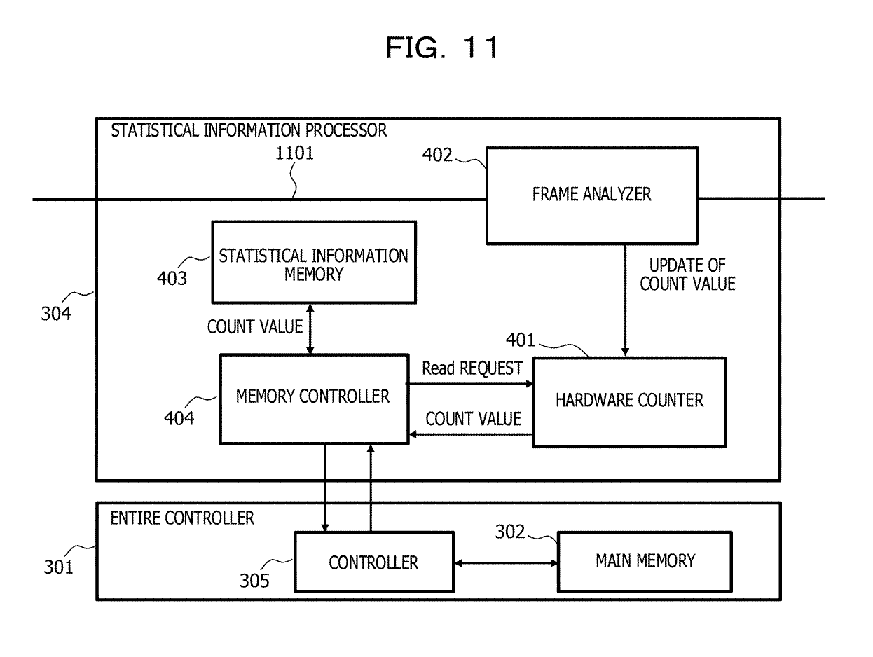

FIG. 11 is a diagram illustrating a detailed example configuration of each of the statistical information processors 304 (#1), 304 (#2) of FIG. 9. The statistical information processor 304 includes a frame analyzer 402, a hardware counter 401, a memory controller 404, and a statistical information memory 403. These components 401 to 404 are equivalent to what has been described with reference to FIG. 4.

First, the frame analyzer 402 performs frame analysis on received data inputted from a transmission path 1101, thereby obtaining statistical information (count-up value) and the identification information on an entry to which the frame belongs, and updates the hardware counter 401. Here, when the statistical information processor 304 performs processing as a frame counter, the count value is incremented by 1 at a time. When the statistical information processor 304 operates as a byte (octet) counter, the count value is incremented by a byte.

Next, the memory controller 404 transmits a Read request for the count value to the hardware counter 401 for every polling cycle (interval of 1 second). The count of the hardware counter 401, which reads the count value, is cleared to zero by Read-Clear operation. The memory controller 404 accumulatively stores the read count value in the statistical information memory 403 as statistical information. The memory controller 404 performs this process for the number of all FPs or for a limited number of FPs.

The controller 305 in the entire controller 301 collects statistical information from the statistical information memory 403 in the statistical information processor 304 in each IF unit 201 via the memory controller 404 at the timing of the bind cycle mentioned above in FIG. 6. As described above, when a cumulative value of statistical information exceeds a predetermined threshold value during collection of statistical information, the memory controller 404 notifies the controller 305 and a maintenance person of TCA indicating a threshold value is exceeded.

The procedure for practicing the present embodiment is roughly divided into the following three steps:

(1) Registration of the Path table 303.

(2) Issuing a notification of priority collection/notification of stop collection of statistical information.

(3) Control of collection frequency of statistical information.

First, the registration of the Path table 303 mentioned above in (1) will be described. The entire controller 301 performs registration processing of the Path table 303 for instance when the transmission device 104 is installed.

As described above in FIG. 3, in addition to “Path” item, “input FP” item, and “output FP” item, each entry (row) of the Path table 303 has “link” item to which link information indicating a physical route through a path corresponding to the entry is registered.

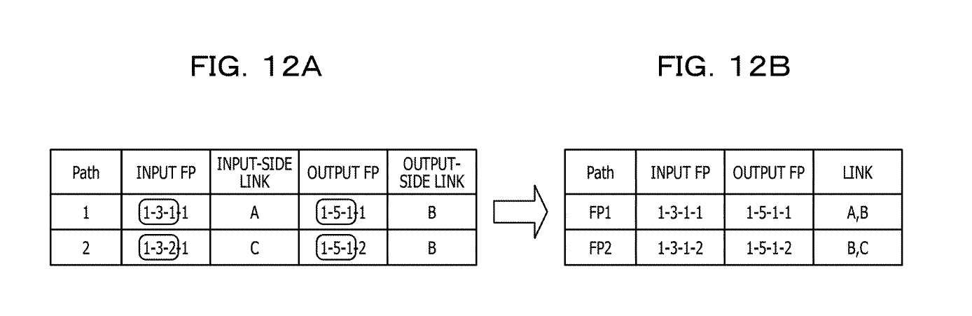

Specifically, the entire controller 301 sets a link using a combination of Shelf number-Slot number-Port number as a link component. For instance, as illustrated in FIG. 12A, a case is discussed in which two paths are provided which are path 1 identified by a combination of the input FP “1-3-1-1” and the output FP “1-5-1-1”, and path 2 identified by a combination of the input FP “1-3-2-1” and the output FP “1-5-1-2”.

In this case, as illustrated in FIG. 12A, for Path 1, the entire controller 301 sets input-side link A to “1-3-1” based on the input FP “1-3-1-1” and output side link B to “1-5-1” based on the output FP “1-5-1-1” on the memory 302. Similarly, the entire controller 301 sets input-side link C to “1-3-2” based on the input FP “1-3-2-1” and output side link B to “1-5-1” based on the output FP “1-5-1-2” in the memory 302. The entire controller 301 then generates Path table 303 illustrated in FIG. 12B, similar to the table illustrated in FIG. 3 based on the details of the setting in the memory 302.

Next, (2) issuing a notification of priority collection/notification of stop collection of statistical information mentioned above will be described. The cause of issuing a notification of priority collection is roughly divided into the following two patterns:

I. An increase (deterioration of performance) in the amount of statistical information (such as the number of discarded packets).

II. Occurrence of alert due to signal interruption, such as a LOS alert

In the case of pattern I, a threshold value for issuing a priority collection notification during collection of statistical information (such as the number of discarded packets) is pre-set. When the amount (such as the number of discarded packets) of statistical information exceeds a threshold value, the memory controller 404 (FIG. 12A and FIG. 12B) in the statistical information processor 304 (FIG. 9) with #1 or #2 notifies the controller 305 in the entire controller 301 of TCA. Upon detecting a notification of TCA, the controller 305 searches for the “link” item (see FIG. 12B) of the Path table 303 in the memory 302. The controller 305 then identifies an FP (output FP) for which collection priority is to be increased. The controller 305 transmits a notification of priority collection of statistical information to the statistical information processor 304 in each interface card 201, to which the identified FP belongs, in the subsequent stage.

On the other hand, in the case of pattern II, an alert of signal interruption such as a LOS alert is sent from a relevant port in the interface card 201 to the controller 305 in the entire controller 301. Upon detecting a notification of a signal interruption alert, the controller 305 searches for the “link” item of the Path table 303 in the memory 302. The controller 305 then identifies an FP (output FP) for which collection of statistical information is to be stopped. The controller 305 transmits a notification of stop collection of statistical information to the statistical information processor 304 in each interface card 201, to which the identified FP belongs, in the subsequent stage.

The detailed control operation performed by the controller 305 related to patterns I and II mentioned above FIG. 3 has been described above with reference to FIG. 3.

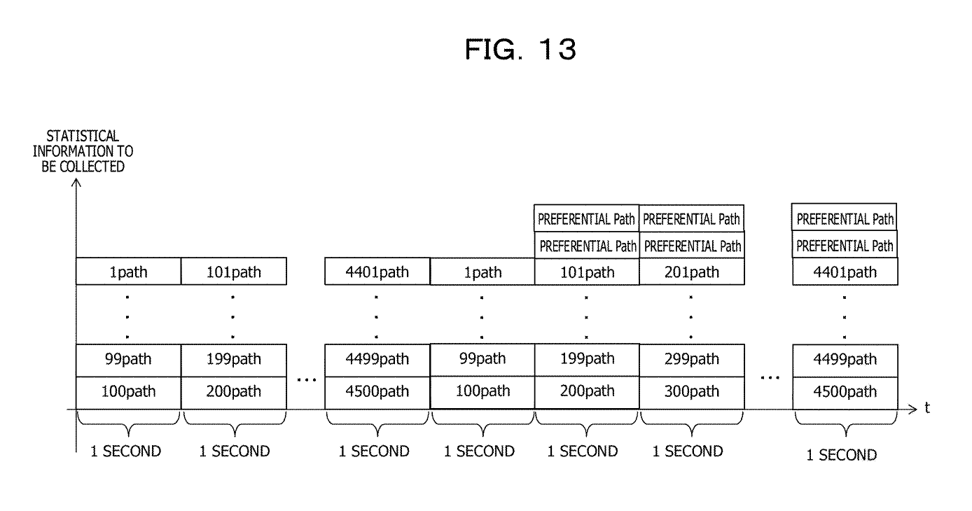

Finally, (3) control of collection frequency of statistical information mentioned above will be described. Upon receiving a notification of priority collection for a specific FP in the above-described step (2), the memory controller 404 in the statistical information processor 304 in each interface card 201 in the subsequent stage performs the following operation. The memory controller 404 controls the schedule for collecting statistical information so that statistical information for the FP designated by the received notification of priority collection is collected for every polling cycle (every one second) as indicated as a “preferential Path” in FIG. 13. Consequently, based on performance deterioration of a specific FP occurred in another interface card 201, the statistical information processor 304 of interface the card 201, which handles an FP sharing a link used by the specific FP, starts to collect statistical information for every cycle. This enables notification of TCA for every one second for the preferential Path.

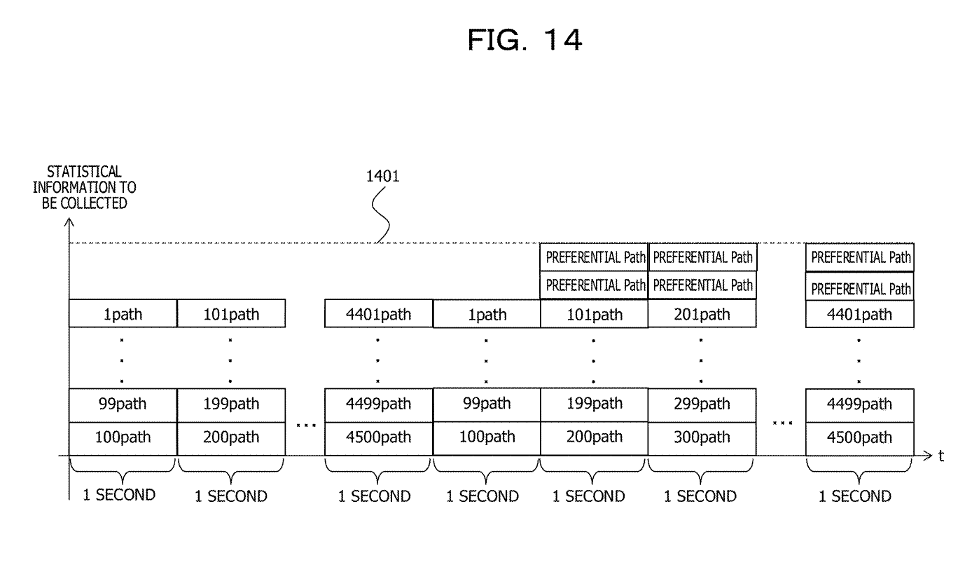

When deterioration of performance is suspected due to increased number of collection in every polling cycle, a maximum number of collections per polling cycle is designated in advance at the time of registration as indicated as 1401 of FIG. 14. In a normal time, the number of collection is limited to approximately 80 to 90% of the maximum number of collection, and when an alert occurs, the remaining number of collection may be used for priority collection.

Furthermore, when the number of collection exceeds 100% of the maximum number of collection, exceeded collection may be made in the subsequent polling cycle.

Upon receiving a notification of stop collection of statistical information in the above-described step (2), the memory controller 404 in the statistical information processor 304 in each interface card 201 in the subsequent stage performs the following operation. The memory controller 404 controls the schedule for collecting statistical information so that collection of statistical information for the FP designated by the notification of stop collection is stopped (reading is not performed).

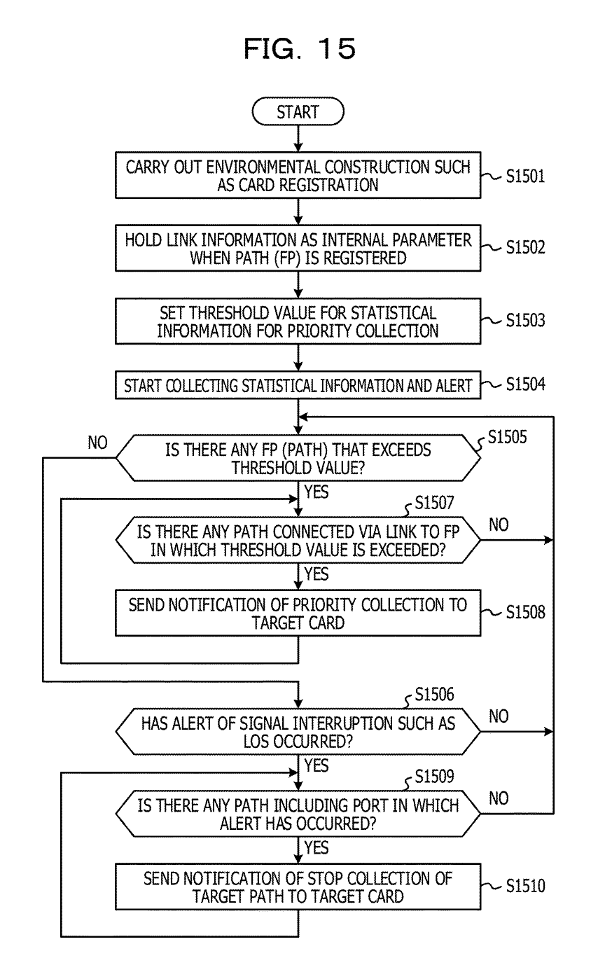

FIG. 15 is a flow chart illustrating an example of statistical information collection control processing performed by the entire controller 301 of FIG. 9. The processing is such that a CPU which is not particularly illustrated in the entire controller 301 loads a statistical information collection control processing program from a read only memory (ROM) which is not particularly illustrated to the memory 302 and executes the program.

First, a maintenance person carries out environmental construction (system construction) for signal communication, such as card registration from an input device which is not particularly illustrated. After this step, the entire controller 301 registers relevant information on the memory 302 (S1501).

Subsequently, the entire controller 301 holds the above-described link information in the memory 302 as internal parameters (S1502) when the above-described Path table 303 is registered.

Subsequently, a maintenance person sets threshold values for statistical information for priority collection (as a system, default threshold values may be coded into software). After this step, the entire controller 301 holds the threshold values in the memory 302 (S1503).

Subsequently, the entire controller 301 commands the statistical information processor 304 (FIG. 9) in each interface card 201 to start collecting statistical information and alerts (S1504).

After this step, the controller 305 in the entire controller 301 is in a standby state in which the processing in S1505 and S1506 is repeatedly performed. The controller 305 determines in S1505 whether or not a TCA related to an FP (path) in which a threshold value is exceeded has been sent from the statistical information processor 304 in one of the interface cards 201. When the determination in S1505 indicates NO, the controller 305 determines in S1506 whether or not a notification of an alert of signal interruption such as LOS has been issued from one of the interface cards 201. When the determination in S1506 also indicates NO, the operation of the controller 305 returns to the standby determination processing in S1505.

When the determination in S1505 indicates YES, the controller 305 refers to the Path table 303 in the memory 302 to search for a path which is connected via a link to an FP in which a threshold value is exceeded, as described above with reference to FIG. 3 (S1507).

When the determination in S1507 indicates NO, the operation of the controller 305 returns to the standby determination processing in S1505.

When the determination in S1507 indicates YES, the controller 305 transmits a notification of priority collection to the statistical information processor 304 in association with the path retrieved in S1507 in each interface card 201 in the subsequent stage, the notification related to an FP corresponding to the retrieved path (S1508).

Subsequently, the operation of the controller 305 returns to the processing in S1507, and further refers to the Path table 303 to search for another path which is connected via a link to the FP in which a threshold value is exceeded.

When the determination in S1506 indicates YES, the controller 305 refers to the Path table 303 in the memory 302 to search for a path including a port in which an alert has occurred, as described above with reference to FIG. 3 (S1509).

When the determination in S1509 indicates NO, the operation of the controller 305 returns to the standby determination processing in S1505.

When the determination in S1509 indicates YES, the controller 305 transmits a notification of stop collection to the statistical information processor 304 in association with the path retrieved in S1509 in each interface card 201 in the subsequent stage, the notification related to an FP corresponding to the retrieved path (S1510).

Subsequently, the operation of the controller 305 returns to the processing in S1509, and further refers to the Path table 303 to search for another path including a port in which an alert has occurred.

According to the embodiment described above, in the collection of statistical information in the transmission device having a large number of paths, it is possible to notify the units in the subsequent stage of a notification of TCA which has occurred in a unit on the input side without delay. Since unnecessary statistical information is not collected in the units in the subsequent stage based on a notification of an alert of signal interruption such as a LOS alert which has occurred in a unit on the input side, it is possible to reduce CPU load. Thus, according to the present embodiment, each unit in the subsequent stage may be notified of information on deterioration of performance or signal interruption in the input-side units without delay, and in the unit in the subsequent stage, the priority (frequency) of collection of statistical information may be changed so that notification of TCA may be made appropriately.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing method executed by a transmission device coupled to a plurality of communication paths, the transmission device including an input-side first interface device and a plurality of second interface devices in a subsequent stage of the first interface device, the information processing method comprising:
obtaining, by the first interface device, statistical information on the plurality of communication paths at predetermined time intervals;
when it is determined that a path in which a cumulative value of the statistical information exceeds a predetermined threshold value or a path in which loss of communication occurs is detected in the plurality of communication paths, notifying a relevant interface device of an alert, the relevant interface device being one of the plurality of second interface devices and using the detected path; and
changing, by the relevant interface device, a frequency of obtaining the statistical information corresponding to at least the detected path, when the alert is received from the first interface device.

2. The information processing method according to claim 1,
wherein the changing includes increasing the frequency of obtaining the statistical information corresponding to the detected path, when it is determined that a path in which the cumulative value of the statistical information exceeds a predetermined threshold value is detected in the plurality of communication paths.

3. The information processing method according to claim 2,
wherein the increasing the frequency includes changing a schedule of collection so that the statistical information corresponding to the detected path is obtained each time at predetermined time intervals.

4. The information processing method according to claim 2,
wherein the changing includes stopping obtaining the statistical information corresponding to the detected path, when it is determined that a path in which loss of communication occurs is detected in the plurality of communication paths.

5. The information processing method according to claim 1, wherein
the obtaining includes setting a priority for each of the plurality of communication paths, and
the changing the frequency includes changing the priority set for each of the plurality of communication paths.

6. The information processing method according to claim 1,
wherein the transmission device stores, for each of the plurality of communication paths, a path table including information on a link that uses the path, and
the notifying includes identifying the relevant interface device from among the plurality of second interface devices by referring to the path table, when it is determined that a path in which a cumulative value of statistical information exceeds a predetermined threshold value or a path in which loss of communication occurs is detected in the plurality of communication paths.

7. The information processing method according to claim 6,
wherein each of the first interface device and the plurality of second interface devices is an interface card inserted in one of slots which are provided in a housing of the transmission device and each of which is assigned a slot number.

8. The information processing method according to claim 7,
wherein the path table stores, for each of the plurality of communication paths:
input-side link identification information related to an input-side interface card and an input-side port to be used, the input-side link identification information indicating a combination of a shelf number that identifies the housing, the slot number, and a number of the port, and
output-side link identification information related to an output-side interface card and an output-side port to be used, the output-side link identification information indicating a combination of a shelf number that identifies the housing, the slot number, and a number of the port.

9. The information processing method according to claim 8,
wherein the path table further stores, for each of the plurality of communication paths, an input-side flow point that is generated by a combination of the input-side link identification, and a sequence number assigned to a path on the input-side interface card, and an output-side flow point that is generated by a combination of the output-side link identification, and a sequence number assigned to the path on the output-side interface card.

10. A transmission device coupled to a plurality of communication paths, the transmission device comprising:
an input-side first interface device; and
a plurality of second interface devices in a subsequent stage of the first interface device,
wherein the first interface device is configured to:
obtain statistical information on the plurality of communication paths at predetermined time intervals, and
when it is determined that a path in which a cumulative value of the statistical information exceeds a predetermined threshold value or a path in which loss of communication occurs is detected in the plurality of communication paths, notify a relevant interface device of an alert, the relevant interface device being one of the plurality of second interface devices and using the detected path,
wherein the relevant interface device is configured to
change a frequency of obtaining the statistical information corresponding to at least the detected path, when the alert is received from the first interface device.

11. A non-transitory computer-readable storage medium storing a program that causes a transmission device coupled to a plurality of communication paths to execute a process, the transmission device including an input-side first interface device and a plurality of second interface devices in a subsequent stage of the first interface device, the process comprising:
obtaining, by the first interface device, statistical information on the plurality of communication paths at predetermined time intervals;
when it is determined that a path in which a cumulative value of the statistical information exceeds a predetermined threshold value or a path in which loss of communication occurs is detected in the plurality of communication paths, notifying a relevant interface device of an alert, the relevant interface device being one of the plurality of second interface devices and using the detected path; and
changing, by the relevant interface device, a frequency of obtaining the statistical information corresponding to at least the detected path, when the alert is received from the first interface device, the statistical information.
